(19) United States
(12) Patent Application Publication
(10) Pub. No.: US 2013/0209861 A1
(43) Pub. Date: Aug. 15, 2013

(54) LITHIUM SECONDARY BATTERY

(71) Applicant: LG Chem, Ltd., (US)

(72) Inventors: Hyun Hang YONG, Seoul (KR); Sang Young LEE, Daejeon (KR); Seok Koo KIM, Daejeon (KR); Soon Ho AHN, Daejeon (KR); Jung Don SUK, Daejeon (KR)

(73) Assignee: LG CHEM, LTD., Seoul (KR)

(21) Appl. No.: 13/795,624

(22) Filed: Mar. 12, 2013

Related U.S. Application Data
(63) Continuation of application No. 11/217,918, filed on Sep. 1, 2005, now Pat. No. 8,409,746.
Application No. 11/217,918 is a continuation of application No. 11/721,020, filed on Jun. 6, 2007.

(30) Foreign Application Priority Data
Sep. 2, 2004 (KR) 10-2004-70095
Sep. 2, 2004 (KR) 10-2004-70096
Dec. 7, 2004 (KR) 10-2004-0102535
Feb. 3, 2005 (KR) 10-2005-9999

(51) Int. Cl. H01M 2/16

(52) U.S. Cl. CPC H01M 2/1686
USPC 429/145; 429/144; 427/58

(57) ABSTRACT

Disclosed is an organic/inorganic composite porous film, having: (a) inorganic particles; and (b) a binder polymer coating layer formed partially or totally on surfaces of the inorganic particles, wherein the inorganic particles are interconnected among themselves and are fixed by the binder polymer, and interstitial volumes among the inorganic particles form a micropore structure. Further disclosed is a porous film having: (a) a porous substrate having pores; and (b) a coating layer formed on at least one region selected from the group consisting of a surface of the substrate and a part of the pores present in the substrate, wherein the coating layer comprises styrene-butadiene rubber. Also disclosed is an electrochemical device containing the organic/inorganic composite porous film, a method of manufacturing the film.

This application is a continuation of U.S. patent application Ser. No. 11/217,918, filed Sep. 1, 2005, and claims priority to and the benefit of Korean Patent Application No. 10-2004-0070095, filed on Sep. 2, 2004, and Korean Patent Application No. 10-2004-0070096, filed on Sep. 2, 2004, which are hereby incorporated by reference in their entirety for all purposes as if fully set forth herein. This application is also a continuation of U.S. patent application Ser. No. 11/721,020, filed Jun. 6, 2007, which claims the benefit of PCT/KR2005/004174, filed on Dec. 7, 2005 and claims priority to and the benefit of Korean Patent Application No. 10-2004-0102535, filed on Dec. 7, 2004, which are hereby incorporated by reference in their entirety for all purposes as if fully set forth herein.

### TECHNICAL FIELD

The present invention relates to a novel organic/inorganic composite porous film that can show excellent thermal safety and lithium ion conductivity and a high degree of swelling with electrolyte compared to conventional polyolefin-based separators, and an electrochemical device including the same, which ensures safety and has improved quality.

The present invention also relates to a porous film, surfaced-treated with a polymer capable of improving adhesion to other substrates, scratch resistance and wear resistance. The present invention also relates to an electrochemical device including the porous film as a separator.

### BACKGROUND ART

Recently, there is an increasing interest in energy storage technology. Batteries have been widely used as energy sources in portable phones, camcorders, notebook computers, PCs and electric cars, resulting in intensive research and development into them. In this regard, electrochemical devices are subjects of great interest. Particularly, development of rechargeable secondary batteries is the focus of attention.

Secondary batteries are chemical batteries capable of repeated charge and discharge cycles by means of reversible interconversion between chemical energy and electric energy, and may be classified into Ni-MH secondary batteries and lithium secondary batteries. Lithium secondary batteries include lithium secondary metal batteries, lithium secondary ion batteries, lithium secondary polymer batteries, lithium secondary ion polymer batteries, etc.

Because lithium secondary batteries have drive voltage and energy density higher than those of conventional batteries using aqueous electrolytes (such as Ni-MH batteries), they are produced commercially by many production companies. However, most lithium secondary batteries have different safety characteristics depending on several factors. Evaluation of and security in safety of batteries are very important matters to be considered. Therefore, safety of batteries is strictly restricted in terms of ignition and combustion in batteries by safety standards.

In general, a lithium secondary battery is manufactured by forming an assembly of an anode, a cathode, and a separator interposed between both electrodes. In the above assembly, the separator interposed between both electrodes of the battery is a member that serves to prevent an internal short circuit caused by direct contact between the cathode and anode. Also, the separator serves as an ion flow path in the battery, and contributes to the improvement of battery safety.

Currently available lithium ion batteries and lithium ion polymer batteries use polyolefin-based separators in order to prevent short circuit between a cathode and an anode. However, because such polyolefin-based separators have a melting point of 200° C. or less, they have a disadvantage in that they can be shrunk or molten to cause a change in volume when the temperature of a battery is increased by internal and/or external factors. Therefore, there is a great possibility of short-circuit between a cathode and an anode caused by shrinking or melting of separators, resulting in accidents such as explosion of a battery caused by emission of electric energy. As a result, it is necessary to provide a separator that does not cause heat shrinking at high temperature.

To solve the above problems related with polyolefin-based separators, many attempts are made to develop an electrolyte using an inorganic material serving as a substitute for a conventional separator. Such electrolytes may be broadly classified into two types. The first type is a solid composite electrolyte obtained by using inorganic particles having lithium ion conductivity alone or by using inorganic particles having lithium ion conductivity mixed with a polymer matrix. See, Japanese Laid-Open Patent No. 2003-022707, [“Solid State Ionics”—vol. 158, n. 3, p. 275, (2003)], [“Journal of Power Sources”—vol. 112, n. 1, p. 209, (2002)], [“Electrochimica Acta”—vol. 48, n. 14, p. 2003, (2003)], etc. However, it is known that such composite electrolytes are not advisable, because they have low ion conductivity compared to liquid electrolytes and the interfacial resistance between the inorganic materials and the polymer is high while they are mixed.

The second type is an electrolyte obtained by mixing inorganic particles having lithium ion conductivity or not with a gel polymer electrolyte formed of a polymer and liquid electrolyte. In this case, inorganic materials are introduced in a relatively small amount compared to the polymer and liquid electrolyte, and thus merely have a supplementary function to assist in lithium ion conduction made by the liquid electrolyte.

However, because electrolytes prepared as described above have no pores therein or, if any, have pores with a size of several angstroms and low porosity, formed by introduction of an artificial plasticizer, the electrolytes cannot serve sufficiently as separator, resulting in degradation in the battery quality.

In addition, conventional batteries, manufactured in the same manner as described above by using a polyolefin-based separator, frequently cause the problems of poor adhesion and separation between a separator and electrodes, and inefficient lithium ion transfer through the pores of the separator, resulting in degradation in the quality of a battery. Additionally, conventional separators are formed from a chemically stable material, which is not decomposed and does not allow any reaction upon exposure to the oxidative or reductive atmosphere inside a battery, such as polyolefin or fluoropolymer. However, such materials provide insufficient mechanical strength, and thus cause the problems of peel-off or breakage of a separator during the assemblage of a battery, resulting in a drop in the battery safety, caused by an internal short circuit of the battery. Further, conventional separators are coated with inorganic particles in order to improve the heat resistance and to provide a high dielectric constant. However, due to the poor binding force between the separator and inorganic particles, the particles are detached from the separator, and thus it is not possible to obtain desired effects. Therefore, the present invention has been made in view of the above-mentioned problems.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view showing an organic/inorganic composite porous film according to the present invention;

FIG. 2 is a photograph taken by Scanning Electron Microscope (SEM) showing the organic/inorganic composite porous film (PVdF-HFP/BaTiO₃) according to Example 1;

FIG. 3 is a photograph taken by SEM showing a polyolefin-based separator (PP/PE/PP) used in Comparative Example 1;

FIG. 4 is a photograph taken by SEM showing a porous film manufactured by using a plasticizer according to Comparative Example 4;

FIG. 5 is a photograph showing the organic/inorganic composite porous film (PVdF-HFP/BaTiO₃) according to Example 1 compared to a currently used PP/PE/PP separator and PE separator, after each of the samples is maintained at 150° C. for 1 hour;

FIG. 6 is a picture showing the results of an overcharge test for the lithium secondary battery including a currently used PP/PE/PP separator according to Comparative Example 1 and the battery including the organic/inorganic composite porous film (PVdF-HFP/BaTiO₃) according to Example 1;

FIG. 7 is a graph showing variations in ion conductivity depending on the content of inorganic particles, in the organic/inorganic composite porous film according to the present invention;

FIG. 8 is a photograph showing the results of evaluation for the adhesion between an electrode and the organic/inorganic composite porous film (BaTiO₃/PVdF-HFP) coated with styrene-butadiene rubber (SBR) according to Example 10, after laminating the electrode and the porous film;

FIG. 9 is a photograph showing the results of evaluation for the adhesion between an electrode and the organic/inorganic composite porous film (BaTiO₃/PVdF-HFP) according to Comparative Example 5, after laminating the electrode and the porous film;

FIG. 10 is a photograph showing the results of the peeling test performed by using the organic/inorganic composite porous film (BaTiO₃/PVdF-HFP) coated with styrene-butadiene rubber (SBR) according to Example 10; and

FIG. 11 is a photograph showing the results of the peeling test performed by using the organic/inorganic composite porous film (BaTiO₃/PVdF-HFP) according to Comparative Example 5.

### DISCLOSURE OF THE INVENTION

The present inventors have found that an organic/inorganic composite porous film, formed by using (1) inorganic particles and (2) a binder polymer, improves poor thermal safety of a conventional polyolefin-based separator. Additionally, the present inventors have found that because the organic/inorganic composite porous film has a micropore structure formed by the inorganic particles present in the film, it provides an increased volume of space into which a liquid electrolyte infiltrates, resulting in improvements in lithium ion conductivity and degree of swelling with electrolyte. Therefore, the organic/inorganic composite porous film can improve the quality and safety of an electrochemical device using the same as a separator.

In addition, the present inventors have found that when a separator is overcoated with styrene-butadiene rubber (SBR) that imparts excellent adhesion and mechanical strength, on a surface of the separator, or on a part of pores present in the separator, the separator shows improved adhesion to other substrates, preferably to electrodes, and is prevented from peeling-off and breaking during the assemblage of an electrochemical device, so that an electrochemical device using the same separator can provide improved safety and can be prevented from degradation in the quality.

Therefore, the present invention provides an organic/inorganic composite porous film capable of improving the quality and safety of an electrochemical device such as a lithium secondary battery, a method for manufacturing the same and an electrochemical device including the same.

Further, the present invention provides a porous film coated with styrene-butadiene rubber having excellent adhesion and mechanical strength. The present invention also provides an electrochemical device using the porous film as a separator.

According to an aspect of the present invention, there is provided an organic/inorganic composite porous film, which includes (a) inorganic particles; and (b) a binder polymer coating layer formed partially or totally on the surface of the inorganic particles, wherein the organic particles are interconnected among themselves and are fixed by the binder polymer, and interstitial volumes among the inorganic particles form a micropore structure. There is also provided an electrochemical device (preferably, a lithium secondary battery) comprising the same.

According to another aspect of the present invention, there is provided a method for manufacturing an organic/inorganic composite porous film, which includes (a) dissolving a binder polymer into a solvent to form a polymer solution; (b) adding inorganic particles to the polymer solution obtained from step (a) and mixing them; and (c) coating the mixture of inorganic particles with binder polymer obtained from step (b) on a substrate, followed by drying the coated substrate. The substrate may be then detached to provide the organic/inorganic composite porous film.

According to further aspect of the present invention, there is provided a porous film including: (a) a porous substrate having pores; and (b) a coating layer formed on at least one region selected from the group consisting of a surface of the substrate and a part of the pores present in the substrate, wherein the coating layer comprises styrene-butadiene rubber. The present invention also provides an electrochemical device using the porous film as a separator.

Hereinafter, the present invention will be explained in more detail.

### THE FIRST EMBODIMENT

### Organic/Inorganic Composite Porous FILM

The present invention provides a novel organic/inorganic composite porous film, which serves sufficiently as a separator to prevent the electrical contact between a cathode and an anode of a battery and to pass ions therethrough the separator and shows excellent thermal safety, lithium ion conductivity and degree of swelling with electrolyte.

The organic/inorganic composite porous film is obtained by using inorganic particles and a binder polymer. The uniform and heat resistant micropore structure formed by the interstitial volumes among the inorganic particles permits the organic/inorganic composite porous film to be used as a separator. Additionally, if a polymer capable of being gelled when swelled with a liquid electrolyte is used as the binder polymer component, the organic/inorganic composite porous film can serve also as electrolyte.

Particular characteristics of the organic/inorganic composite porous film are as follows.

(1) The organic/inorganic composite porous film according to the present invention shows improved thermal safety by virtue of the inorganic particles present therein.

In other words, although conventional polyolefin-based separators cause heat shrinking at a high temperature because they have a melting point of 120-140° C., the organic/inorganic composite porous film having the inorganic particles and binder polymer does not cause heat shrinking due to the heat resistance of the inorganic particles. Therefore, an electrochemical device using the above organic/inorganic composite porous film as a separator causes no degradation in safety resulting from an internal short circuit between a cathode and an anode even under extreme conditions such as high temperature, overcharge, etc. As a result, such electrochemical devices have excellent safety characteristics compared to conventional batteries.

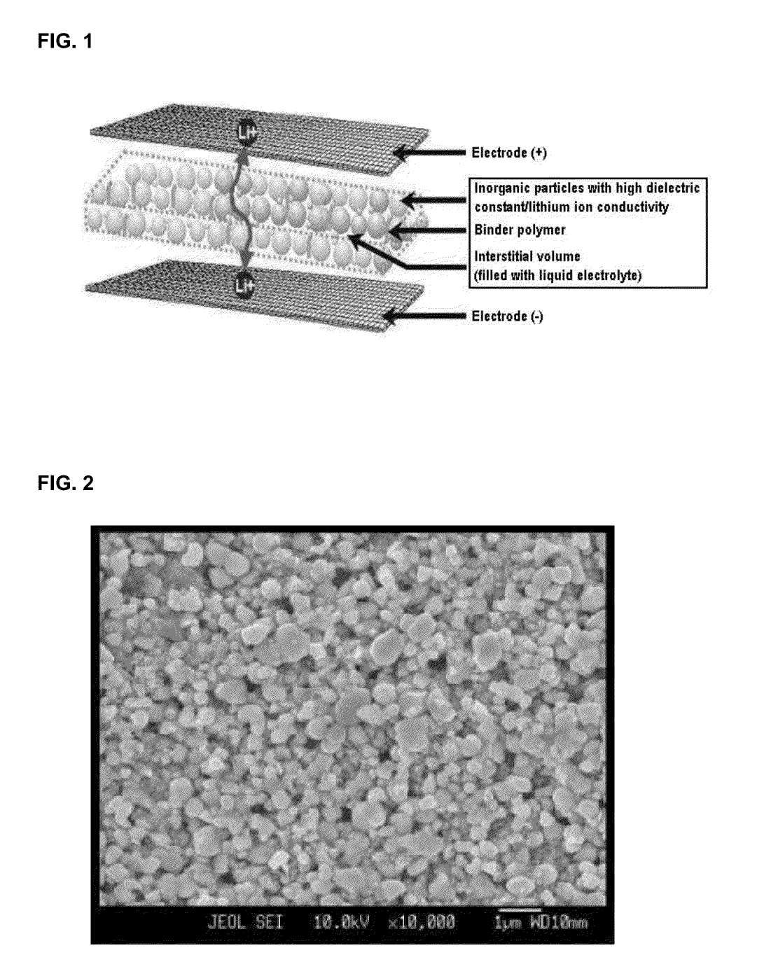

(2) Conventional solid electrolytes formed by using inorganic particles and a binder polymer have no pore structure or, if any, have an irregular pore structure having a pore size of several angstroms. Therefore, they cannot serve sufficiently as a spacer, through which lithium ions can pass, resulting in degradation in the quality of a battery. On the contrary, the organic/inorganic composite porous film according to the present invention has uniform micropore structures formed by the interstitial volumes among the inorganic particles as shown in FIGS. 1 and 2, and the micropore structures permit lithium ions to move smoothly therethrough. Therefore, it is possible to introduce a large amount of electrolyte through the micropore structures so that a high degree of swelling with electrolyte can be obtained, resulting in improvement in the quality of a battery.

(3) It is possible to control the pore size and porosity of the organic/inorganic composite porous film by varying the particle diameter of the inorganic particles and the mixing ratio of the inorganic particles with the polymer. The micropore structure is subsequently filled with a liquid electrolyte so that the interfacial resistance generating among the inorganic particles or between the inorganic particles and the binder polymer can be reduced significantly.

(4) When the inorganic particles used in the organic/inorganic composite porous film have a high dielectric constant and/or lithium ion conductivity, the inorganic particles can improve lithium ion conductivity as well as heat resistance, thereby contributing to improvement of battery quality.

(5) When the binder polymer used in the organic/inorganic composite porous film is one showing a high degree of swelling with electrolyte, the electrolyte injected after assemblage of a battery can infiltrate into the polymer and the resultant polymer containing the electrolyte infiltrated therein has a capability of conducting electrolyte ions. Therefore, the organic/inorganic composite porous film according to the present invention can improve the quality of an electrochemical device compared to conventional organic/inorganic composite electrolytes. Additionally, the organic/inorganic composite porous film provides advantages in that wettablity with an electrolyte is improved compared to conventional hydrophobic polyolefin-based separators, and use of a polar electrolyte for battery is permitted.

(6) Finally, if the binder polymer is one capable of being gelled when swelled with electrolyte, the polymer reacts with the electrolyte injected subsequently and is gelled, thereby forming a gel type organic/inorganic composite electrolyte. Such electrolytes are produced with ease compared to conventional gel-type electrolytes and show excellent ion conductivity and a high degree of swelling with electrolyte, thereby contributing to improve the quality of a battery.

One component present in the organic/inorganic composite porous film according to the present invention is inorganic particles currently used in the art. The inorganic particles permit interstitial volumes to be formed among them, thereby serving to form micropores and to maintain the physical shape as a spacer. Additionally, because the physical properties of the inorganic particles are not changed even at a high temperature of 200° C. or higher, the organic/inorganic composite porous film using the inorganic particles can have excellent heat resistance.

There is no particular limitation in selection of inorganic particles, as long as they are electrochemically stable. In other words, there is no particular limitation in inorganic particles that may be used in the present invention, as long as they are not subjected to oxidation and/or reduction at the range of drive voltages (for example, 0-5 V based on Li/Li⁺) of a battery, to which they are applied. Particularly, it is preferable to use inorganic particles having ion conductivity as high as possible, because such inorganic particles can improve ion conductivity and quality in an electrochemical device. Additionally, when inorganic particles having a high density are used, they have a difficulty in dispersion during a coating step and may increase the weight of a battery to be manufactured. Therefore, it is preferable to use inorganic particles having a density as low as possible. Further, when inorganic particles having a high dielectric constant are used, they can contribute to increase the dissociation degree of an electrolyte salt in a liquid electrolyte, such as a lithium salt, thereby improving the ion conductivity of the electrolyte.

For these reasons, it is preferable to use inorganic particles having a high dielectric constant of 5 or more, preferably of 10 or more, inorganic particles having lithium conductivity or mixtures thereof.

Particular non-limiting examples of inorganic particles having a dielectric constant of 5 or more include BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃, TiO₂, SiC or mixtures thereof.

As used herein, “inorganic particles having lithium ion conductivity” arereferred to as inorganic particles containing lithium elements and having a capability of conducting lithium ions without storing lithium. Inorganic particles having lithium ion conductivity can conduct and move lithium ions due to defects present in their structure, and thus can improve lithium ion conductivity and contribute to improve battery quality. Non-limiting examples of such inorganic particles having lithium ion conductivity include: lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} type glass (0<x<4, 0<y<13) such as 14Li₂O-9Al₂O₃-38TiO₂-39P₂O₅, lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), such as Li_{3.25}Ge_{0.25}P_{0.75}S₄, lithium nitrides (LiₓN_{y}, 0<x<4, 0<y<2) such as Li₃N, SiS₂ type glass (LiₓSi_{y}S_{z}, 0<x<3, 0<y<2, 0<z<4) such as Li₃PO₄—Li₂S—SiS₂, P₂S₅ type glass (LiₓP_{y}S_{z}, 0<x<3, 0<y<3, 0<z<7) such as Lil-LI₂S—P₂S₅, or mixtures thereof.

According to the present invention, inorganic particles having a relatively high dielectric constant may be used instead of inorganic particles having no reactivity or having relatively low dielectric constant. Further, the present invention also provides a novel use of inorganic particles as separators.

The above-described inorganic particles, that have never been used as separators, for example Pb(Zr,Ti)O₃ (PZT), Pb₁₋ₓLaₓZr_{1-y}Ti_{y}O₃(PLZT), Pb(Mg₃Nb_{2/3})O₃—PbTiO₃(PMN-PT), hafnia (HfO₂), etc., have a high dielectric constant of 100 or more. The inorganic particles also have piezoelectricity so that an electric potential can be generated between both surfaces by the charge formation, when they are drawn or compressed under the application of a certain pressure. Therefore, the inorganic particles can prevent internal short circuit between both electrodes, thereby contributing to improve the safety of a battery. Additionally, when such inorganic particles having a high dielectric constant are combined with inorganic particles having lithium ion conductivity, synergic effects can be obtained.

The organic/inorganic composite porous film according to the present invention can form pores having a size of several micrometers by controlling the size of inorganic particles, content of inorganic particles and the mixing ratio of inorganic particles and binder polymer. It is also possible to control the pore size and porosity.

Although there is no particular limitation in size of inorganic particles, inorganic particles preferably have a size of 0.001-10 μm for the purpose of forming a film having a uniform thickness and providing a suitable porosity. When the size is less than 0.001 μm, inorganic particles have poor dispersibility so that physical properties of the organic/inorganic composite porous film cannot be controlled with ease. When the size is greater than 10 μm, the resultant organic/inorganic composite porous film has an increased thickness under the same solid content, resulting in degradation in mechanical properties. Furthermore, such excessively large pores may increase a possibility of internal short circuit being generated during repeated charge/discharge cycles.

The inorganic particles are present in the mixture of the inorganic particles with binder polymer forming the organic/inorganic composite porous film, preferably in an amount of 50-99 wt %, more particularly in an amount of 60-95 wt % based on 100 wt % of the total weight of the mixture. When the content of the inorganic particles is less than 50 wt %, the binder polymer is present in such a large amount as to decrease the interstitial volume formed among the inorganic particles and thus to decrease the pore size and porosity, resulting in degradation in the quality of a battery. When the content of the inorganic particles is greater than 99 wt %, the polymer content is too low to provide sufficient adhesion among the inorganic particles, resulting in degradation in mechanical properties of a finally formed organic/inorganic composite porous film.

Another component present in the organic/inorganic composite porous film according to the present invention is a binder polymer currently used in the art. The binder polymer preferably has a glass transition temperature (T_{g}) as low as possible, more preferably T_{g} of between −200° C. and 200° C. Binder polymers having a low T_{g} as described above are preferable, because they can improve mechanical properties such as flexibility and elasticity of a finally formed film. The polymer serves as binder that interconnects and stably fixes the inorganic particles among themselves, and thus prevents degradation in mechanical properties of a finally formed organic/inorganic composite porous film.

When the binder polymer has ion conductivity, it can further improve the quality of an electrochemical device. However, it is not essential to use a binder polymer having ion conductivity. Therefore, the binder polymer preferably has a dielectric constant as high as possible. Because the dissociation degree of a salt in an electrolyte depends on the dielectric constant of a solvent used in the electrolyte, the polymer having a higher dielectric constant can increase the dissociation degree of a salt in the electrolyte used in the present invention. The dielectric constant of the polymer may range from 1.0 to 100 (as measured at a frequency of 1 kHz), and is preferably 10 or more.

In addition to the above-described functions, the binder polymer used in the present invention may be gelled when swelled with a liquid electrolyte, and thus shows a high degree of swelling. Therefore, it is preferable to use a polymer having a solubility parameter of between 15 and 45 MPa^{1/2}, more preferably of between 15 and 25 MPa^{1/2}, and between 30 and 45 MPa^{1/2}. Therefore, hydrophilic polymers having a lot of polar groups are more preferable than hydrophobic polymers such as polyolefins. When the binder polymer has a solubility parameter of less than 15 Mpa^{1/2} or greater than 45 Mpa^{1/2}, it has difficulty in swelling with a conventional liquid electrolyte for battery.

Non-limiting examples of the binder polymer that may be used in the present invention include polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, carboxymethyl cellulose, acrylonitrile-styrene-butadiene copolymer, polyimide or mixtures thereof. Other materials may be used alone or in combination, as long as they satisfy the above characteristics.

The organic/inorganic composite porous film may further include additives other than the inorganic particles and binder polymer.

When the organic/inorganic composite porous film is manufactured by using inorganic particles and a binder polymer, the film may be realized by three types of embodiments, but is not limited thereto.

The first type is an organic/inorganic composite porous film formed by using a mixture of inorganic particles and binder polymer with no additional substrate. The second type is an organic/inorganic composite porous film formed by coating the mixture on a porous substrate having pores, wherein the film coated on the porous substrate includes an active layer obtained by coating the mixture of inorganic particles and binder polymer on the surface of the porous substrate or on a part of the pores in the substrate. The third type is an organic/inorganic composite porous film formed by coating the mixture on a cathode and/or an anode. The third type is a monolithic electrode and film.

In the second embodiment of the organic/inorganic composite porous film according to the present invention, there is no particular limitation in the substrate coated with the mixture of inorganic particles and binder polymer, as long as it is a porous substrate having pores. However, it is preferable to use a heat resistant porous substrate having a melting point of 200° C. or higher. Such heat resistant porous substrates can improve the thermal safety of the organic/inorganic composite porous film under external and/or internal thermal impacts. Non-limiting examples of the porous substrate having a melting point of 200° C. or higher that may be used include polyethylene terephthalate, polybutylene terephthalate, polyester, polyacetal, polyamide, polycarbonate, polyimide, polyetherether ketone, polyether sulfone, polyphenylene oxide, polyphenylene sulfidro, polyethylene naphthalene or mixtures thereof. However, other heat resistant engineering plastics may be used with no particular limitation.

Although there is no particular limitation in thickness of the porous substrate, the porous substrate preferably has a thickness of between 1 μm and 100 μm, more preferably of between 5 μm and 50 μm. When the porous substrate has a thickness of less than 1 μm, it is difficult to maintain mechanical properties. When the porous substrate has a thickness of greater than 100 μm, it may function as a resistance layer.

Although there is no particular limitation in pore size and porosity of the porous substrate, the porous substrate preferably has a porosity of between 5% and 95%. The pore size (diameter) preferably ranges from 0.01 μm to 50 μm, more preferably from 0.1 μm to 20 μm. When the pore size and porosity are less than 0.01 μm and 5%, respectively, the porous substrate may function as a resistance layer. When the pore size and porosity are greater than 50 μm and 95%, respectively, it is difficult to maintain mechanical properties.

The porous substrate may take the form of a membrane or fiber. When the porous substrate is fibrous, it may be a nonwoven web forming a porous web (preferably, spunbond type web having long fibers or melt blown type web).

A spunbond process is performed continuously through a series of steps and provides long fibers formed by heating and melting, which is stretched, in turn, by hot air to form a web. A melt blown process performs spinning of a polymer capable of forming fibers through a spinneret having several hundreds of small orifices, and thus provides three-dimensional fibers having a spider-web structure resulting from interconnection of microfibers having a diameter of 10 μm or less.

The organic/inorganic composite porous film that may be formed in various types of embodiments according to the present invention has a micropore structure. First, the organic/inorganic composite porous film formed by using the mixture of inorganic particles and polymer alone has a micropore structure formed by interstitial volumes among the inorganic particles serving as support as well as spacer. Next, the organic/inorganic composite porous film formed by coating the mixture on a porous substrate has pore structures present both in the substrate and in the active layer due to the pores present in the porous substrate itself and interstitial volumes among the inorganic particles in the active layer formed on the substrate. Finally, the organic/inorganic composite porous film obtained by coating the mixture on the surface of an electrode has a uniform pore structure formed by interstitial volumes among the inorganic particles in the same manner as the pore structure formed by electrode active material particles in the electrode. Therefore, an embodiment of the organic/inorganic composite porous film according to the present invention has an increased volume of space, into which an electrolyte infiltrates, by virtue of such micropore structures. As a result, it is possible to increase dispersibility and conductivity of lithium ions, resulting in improvement in the quality of a battery.

The pore size and porosity of the organic/inorganic composite porous film mainly depend on the size of inorganic particles. For example, when inorganic particles having a particle diameter of 1 μm or less are used, pores formed thereby also have a size of 1 μm or less. The pore structure is filled with an electrolyte injected subsequently and the electrolyte serves to conduct ions. Therefore, the size and porosity of the pores are important factors in controlling the ion conductivity of the organic/inorganic composite porous film. Preferably, the pores size and porosity of the organic/inorganic composite porous film according to the present invention range from 0.01 to 10 μm and from 5 to 95%, respectively.

There is no particular limitation in thickness of the organic/inorganic composite porous film according to the present invention. The thickness may be controlled depending on the quality of a battery. According to the present invention, the film preferably has a thickness of between 1 and 100 μm, more preferably of between 2 and 30 μm. Control of the thickness of the film may contribute to improve the quality of a battery.

There is no particular limitation in mixing ratio of inorganic particles to polymer in the organic/inorganic composite porous film according to the present invention. The mixing ratio can be controlled according to the thickness and structure of a film to be formed finally.

The organic/inorganic composite porous film may be applied to a battery together with a microporous separator (for example, a polyolefin-based separator), depending on the characteristics of a finally formed battery.

The organic/inorganic composite porous film may be manufactured by a conventional process known to one skilled in the art. One embodiment of a method for manufacturing the organic/inorganic composite porous film according to the present invention, includes the steps of: (a) dissolving a binder polymer into a solvent to form a polymer solution; (b) adding inorganic particles to the polymer solution obtained from step (a) and mixing them; and (c) coating the mixture obtained from step (b) on the surface of a substrate, followed by drying, and then detaching the substrate.

Hereinafter, the method for manufacturing the organic/inorganic composite porous film according to the present invention will be explained in detail.

(1) First, a binder polymer is dissolved in a suitable organic solvent to provide a polymer solution.

It is preferable that the solvent has a solubility parameter similar to that of the binder polymer to be used and a low boiling point. Such solvents can be mixed uniformly with the polymer and can be removed easily after coating the polymer. Non-limiting examples of the solvent that may be used include acetone, tetrahydrofuran, methylene chloride, chloroform, dimethylformamide, N-methyl-2-pyrrolidone (NMP), cyclohexane, water and mixtures thereof.

(2) Next, inorganic particles are added to and dispersed in the polymer solution obtained from the preceding step to provide a mixture of inorganic particles with binder polymer.

It is preferable to perform a step of pulverizing inorganic particles after adding the inorganic particles to the binder polymer solution. The time needed for pulverization is suitably 1-20 hours. The particle size of the pulverized particles ranges preferably from 0.001 and 10 μm. Conventional pulverization methods, preferably a method using a ball mill may be used.

Although there is no particular limitation in composition of the mixture containing inorganic particles and binder polymer, such composition can contribute to control the thickness, pore size and porosity of the organic/inorganic composite porous film to be formed finally.

In other words, as the weight ratio (I/P) of the inorganic particles (I) to the polymer (P) increases, porosity of the organic/inorganic composite porous film according to the present invention increases. Therefore, the thickness of the organic/inorganic composite porous film increases under the same solid content (weight of the inorganic particles+weight of the binder polymer). Additionally, the pore size increases in proportion to the pore formation among the inorganic particles. When the size (particle diameter) of inorganic particles increases, interstitial distance among the inorganic particles also increases, thereby increasing the pore size.

(3) The mixture of inorganic particles with binder polymer is coated on a substrate, followed by drying, and then the substrate is detached to provide the organic/inorganic composite porous film.

Particular examples of the substrate that may be used include Teflon sheets or the like generally used in the art, but are not limited thereto.

In order to coat the porous substrate with the mixture of inorganic particles and binder polymer, any methods known to one skilled in the art may be used. It is possible to use various processes including dip coating, die coating, roll coating, comma coating or combinations thereof.

In this step, when the substrate is a porous substrate having pores or a preformed electrode, various types of organic/inorganic composite porous films can be obtained. The mixture of inorganic particles and polymer may be coated on the surface of porous substrate, on the surface of electrode, and on a part of the pores present in the substrate. In this step, the step of detaching a substrate may be omitted.

The organic/inorganic composite porous film according to the present invention, obtained as described above, may be used as a separator in an electrochemical device, preferably in a lithium secondary battery. Additionally, the organic/inorganic composite porous film may be coated with a conventional polymer (for example, a polymer capable of being swelled with an electrolyte) on one surface or both surfaces so as to be used as a separator.

If the binder polymer used in the film is a polymer capable of being gelled when swelled with a liquid electrolyte, the polymer may react with the electrolyte injected after assembling a battery by using the separator, and thus be gelled to form a gel type organic/inorganic composite electrolyte.

The gel type organic/inorganic composite electrolyte according to the present invention is prepared with ease compared to gel type polymer electrolytes according to the prior art, and has a large space to be filled with a liquid electrolyte due to its microporous structure, thereby showing excellent ion conductivity and a high degree of swelling with electrolyte, resulting in improvement in the quality of a battery.

Further, the present invention provides an electrochemical device including: (a) a cathode; (b) an anode; (c) the organic/inorganic composite porous film according to the present invention, interposed between the cathode and anode; and (d) an electrolyte.

Such electrochemical devices include any devices in which electrochemical reactions occur and particular examples thereof include all kinds of primary batteries, secondary batteries, fuel cells, solar cells or capacitors. Particularly, the electrochemical device is a lithium secondary battery including a lithium secondary metal battery, lithium secondary ion battery, lithium secondary polymer battery or lithium secondary ion polymer battery.

According to the present invention, the organic/inorganic composite porous film contained in the electrochemical device serves as a separator. If the polymer used in the film is a polymer capable of being gelled when swelled with electrolyte, the film may serve also as electrolyte.

In addition to the above organic/inorganic composite porous film, a microporous separator may also be used. Particular examples of the microporous separator that may be used includes currently used polyolefin-based separators or at least one porous substrate having a melting point of 200° C., selected from the group consisting of polyethylene terephthalate, polybutylene terephthalate, polyester, polyacetal, polyamide, polycarbonate, polyimide, polyetherether ketone, polyether sulfone, polyphenylene oxide, polyphenylene sulfidro and polyethylene naphthalene.

The electrochemical device may be manufactured by a conventional method known to one skilled in the art. In one embodiment of the method for manufacturing the electrochemical device, the electrochemical device is assembled by using the organic/inorganic composite porous film interposed between a cathode and an anode, and then an electrolyte is injected.

The electrode that may be applied together with the organic/inorganic composite porous film according to the present invention may be formed by applying an electrode active material on a current collector according to a method known to one skilled in the art. Particularly, cathode active materials may include any conventional cathode active materials currently used in a cathode of a conventional electrochemical device. Particular non-limiting examples of the cathode active material include lithium intercalation materials such as lithium manganese oxides, lithium cobalt oxides, lithium nickel oxides, lithium iron oxides or composite oxides thereof. Additionally, anode active materials may include any conventional anode active materials currently used in an anode of a conventional electrochemical device. Particular non-limiting examples of the anode active material include lithium intercalation materials such as lithium metal, lithium alloys, carbon, petroleum coke, activated carbon, graphite or other carbonaceous materials. Non-limiting examples of a cathode current collector include foil formed of aluminum, nickel or a combination thereof. Non-limiting examples of an anode current collector include foil formed of copper, gold, nickel, copper alloys or a combination thereof.

The electrolyte that may be used in the present invention includes a salt represented by the formula of A⁺B⁻, wherein A⁺ represents an alkali metal cation selected from the group consisting of Li⁺, Na⁺, K⁺ and combinations thereof, and B⁻ represents an anion selected from the group consisting of PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻ and combinations thereof. The salt may be dissolved or dissociated in an organic solvent selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL) and mixtures thereof. However, the electrolyte that may be used in the present invention is not limited to the above examples.

More particularly, the electrolyte may be injected in a suitable step during the manufacturing process of an electrochemical device, according to the manufacturing process and desired properties of a final product. In other words, electrolyte may be injected, before an electrochemical device is assembled or in a final step during the assemblage of an electrochemical device.

Processes that may be used for applying the organic/inorganic composite porous film to a battery include not only a conventional winding process but also a lamination (stacking) and folding process of a separator and electrode.

When the organic/inorganic composite porous film according to the present invention is applied to a lamination process, the thermal safety of a battery can be significantly improved. It is because a battery formed by a lamination and folding process generally shows more severe heat shrinking of a separator compared to a battery formed by a winding process. Additionally, when a lamination process is used, there is an advantage in that a battery can be assembled with ease by virtue of excellent adhesion of the polymer present in the organic/inorganic composite porous film according to the present invention. In this case, the adhesion can be controlled depending on the content of inorganic particles and polymer, and properties of the polymer. More particularly, as the polarity of the polymer increases and as the glass transition temperature (T_{g}) or melting point (Tₘ) of the polymer decreases, the adhesion between the organic/inorganic composite porous film and electrode can be greater.

### THE SECOND EMBODIMENT

### Surface-Treated Microporous Membrane

In the porous film according to an embodiment of the present invention, the surface of the porous substrate and/or a part of the pores present in the substrate is coated with styrene-butadiene rubber. Such coated porous film can improve the safety of a battery and prevent degradation in the quality of a battery by virtue of the physical properties of styrene-butadiene rubber.

(1) The porous film coated with styrene-butadiene rubber on the surface of the porous substrate having pores and/or on a part of the pores present in the porous substrate can improve the safety of a battery.

As described above, conventional separators generally use polyolefin polymers. However, polyolefin polymers have insufficient mechanical strength, and thus cause the problems of peel-off and breakage of separators during the assemblage of a battery, resulting in degradation in the safety of a battery, caused by an internal short circuit, or the like.

On the contrary, the porous film according to the embodiment of the present invention has improved scratch resistance and maintains the pore structure present in the film over a longer period of time, by virtue of the rubbery characteristics provided by low glass transition temperature (Tg) of styrene-butadiene rubber. Therefore, an electrochemical device including the porous film as a separator can provide improved safety.

Additionally, when the styrene-butadiene rubber used in the porous film includes a hydrophilic functional group, the porous film can show more improved adhesion. Hence, the porous film according to the embodiment of the present invention maintains to be in close contact with other substrates (e.g. electrodes) continuously, so that both electrodes can be prevented from being in direct contact with each other due to a drop in external stress and degradation in the thermal safety of a separator, caused by internal or external factors. Therefore, it is possible to prevent an internal short circuit.

Further, as described above, when inorganic particles are dispersed or coated on a conventional polyolefin-based separator in order to improve the heat resistance and conductivity, the inorganic particles coated on the separator are detached from the separator, and thus it is not possible to obtain desired effects. However, in the porous film according to the present invention, a styrene-butadiene rubber coating layer is introduced onto an organic/inorganic composite porous film having a pore structure formed by interstitial volumes of the inorganic particles, while maintaining the pore structure as it is. Therefore, it is possible to realize excellent adhesive property provided by styrene-butadiene rubber, while maintaining the effects of improving heat resistance and mechanical strength, provided by the inorganic particles. Particularly, when styrene-butadiene rubber is coated on the surface of the porous film and infiltrates into a part of the pores present in the film, it is possible to generate synergy of the above effects.

(2) The porous film coated with styrene-butadiene rubber on the surface of the porous substrate having pores and/or on a part of the pores present in the porous substrate can prevent degradation in the quality of a battery.

In a conventional process for assembling a battery, for example, by interposing a separator between a cathode and an anode of a battery, the electrodes and separator are frequently separated from each other due to poor adhesion between them. Thus, during the electrochemical reaction in the battery, lithium ion transfer cannot be performed efficiently through the pores of the separator, resulting in degradation in the quality of a battery.

However, in the porous film coated with styrene-butadiene rubber according to the present invention, it is possible to provide excellent adhesion by controlling the kinds and amounts of monomers during the preparation of the styrene-butadiene rubber. Therefore, continuous lithium ion transfer can be occurred because the close contact between the porous film and electrodes is maintained during the electrochemical reaction in the battery as well as the process for assembling a battery, so that degradation in the battery quality can be prevented.

(3) The porous film according to an embodiment of the present invention is obtained by coating (i) a porous substrate having pores; (ii) an organic/inorganic composite porous film, which includes a porous film having pores, coated with a coating layer having a mixture of inorganic particles with a binder polymer, on the surface of the porous substrate and/or on a part of the pores present in the porous substrate; and (iii) an organic/inorganic composite porous film having inorganic particles and a binder polymer coating layer partially or totally formed on the surface of the inorganic particles, directly with styrene-butadiene rubber. Hence, the inorganic particles are linked and fixed among themselves by the pores present on the surface of the porous substrate and the binder polymer. Additionally, interstitial volumes of the inorganic particles permit the pore structure of the active layer type or freestanding type organic/inorganic composite porous film to be maintained as it is, and the pore structure and the styrene-butadiene rubber coating layer are bonded physically and firmly with each other. Therefore, it is possible to solve the problem of poor mechanical properties, such as brittleness. Additionally, a liquid electrolyte, injected through the pore structure subsequently, significantly reduces the interfacial resistance generated among the inorganic particles and between the inorganic particles and the binder polymer. Further, smooth lithium ion transfer can be accomplished through the pores and a larger amount of electrolyte can be injected through the pore structure, resulting in improvement of the battery quality.

In addition to the above advantages, a separator using the porous film according to the embodiment of the present invention can be prevented from peeling-off and breaking. Hence, it is possible to increase the processability during the assemblage of a battery.

The coating materials for the porous film according to the embodiment of the present invention include styrene-butadiene rubber known to one skilled in the art, with no particular limitation. Styrene-butadiene rubber (SBR) is preferred because it shows a low infiltration ratio to an electrolyte, and thus has little possibility of dissolution or deformation inside a battery. Particularly, SBR having a glass transition temperature (Tg) of room temperature (25° C.) or less is preferred.

Styrene-butadiene rubber (SBR) can be controlled in terms of physical properties so as to be present in a glassy state or rubbery state by adjusting the mixing ratio of a styrene group-containing monomer and a butadiene group-containing monomer, and thus helps to improve the scratch resistance of a separator and safety of a battery. Additionally, SBR may include various kinds and amounts of monomers having hydrophilic functional groups that can form hydrogen bonds with other substrates (e.g. electrodes) to increase the adhesion. Therefore, SBR can provide improved adhesion to an electrode. Considering the above characteristics, SBR that may be used in the present invention preferably has at least one hydrophilic functional group selected from the group consisting of maleic acid, acrylic acid, acrylate, carboxylate, nitrile, hydroxy, mercapto, ether, ester, amide, amine and acetate groups, and halogen atoms.

Styrene-butadiene rubber that may be used in the present invention includes, but is not limited to, SBR obtained by polymerizing: (a) a butadiene group-containing monomer and a styrene group-containing monomer; or (b) a butadiene group-containing monomer, a styrene group-containing monomer and a hydrophilic group-containing monomer known to one skilled in the art, in a conventional manner currently used in the art. There is no particular limitation in the hydrophilic group-containing monomer, and non-limiting examples thereof include monomers containing at least one hydrophilic functional group selected from the group consisting of maleic acid, acrylic acid, acrylate, carboxylic acid, nitrile, hydroxyl and acetate groups.

Herein, the mixing ratio of the styrene group-containing monomer to the butadiene group-containing monomer ranges from 1:99 to 99:1, but is not limited thereto. Preferably, the styrene-butadiene rubber has a styrene group content of 50 wt % or less.

Although there is no particular limitation in the average molecular weight (MW) of the styrene-butadiene rubber, SBR preferably has a molecular weight of 10,000-1,000,000. Also, there is no particular limitation in the form of SBR rubber, SBR rubber is present preferably in the form of an emulsion obtained by solution copolymerization. Because SBR may be used directly in the form of an emulsion or after dispersing it into water, an additional organic solvent and an additional step for removing the same are not required.

The SBR coating layer formed on the porous film preferably has a thickness of 0.001-10 micrometers, but is not limited thereto. If the thickness is less than 0.001 μm, it is not possible to improve the adhesion and mechanical strength sufficiently. On the other hand, if the thickness is greater than 10 μm, the SBR coating layer may serve as a resistance layer, resulting in degradation in the quality of a battery.

The coating layer formed on the porous film according to the present invention may further include other additives known to one skilled in the art, in addition to SBR. Non-limiting examples of such additives include a thickening agent or a silane coupling agent that can enhance the binding force.

The substrate to be coated with SBR according to the present invention includes any porous substrate as long as it serves as a lithium ion flow path and as a space for receiving an electrolyte, regardless of the constitutional elements and composition of the substrate.

The porous substrate may be classified broadly into the following three types, but is not limited thereto. The first type is (a) a conventional separator known to one skilled in the art. The second type is (b) an organic/inorganic composite porous film, which includes a porous film having pores, coated with a coating including a mixture of inorganic particles with a binder polymer, on the surface of the porous substrate and/or on a part of the pores present in the porous substrate. The third type is (c) an organic/inorganic composite porous film including inorganic particles and a binder polymer coating layer partially or totally formed on the surface of the inorganic particles. Combinations of the above types of separators may be used. Herein, the inorganic/organic composite porous films (b) and (c) include the inorganic particles linked and fixed among themselves by the binder polymer, and have a pore structure formed by interstitial volumes of the inorganic particles. Particularly, the inorganic/organic composite porous films (b) and (c) are preferred, because such porous films have little possibility of a complete short circuit between both electrodes due to the presence of the inorganic particles, even if the styrene-butadiene surface coating layer is partially or totally broken in a battery by the external or internal factors. Even if any short circuit is generated, the short circuit zone is inhibited from being extended by the inorganic particles, resulting in improvement of the safety of a battery.

In cases of the separator (a) and organic/inorganic composite porous film (b), non-limiting examples of the porous substrate include polyethylene terephthalate, polybutylene terephthalate, polyester, polyacetal, polyamide, polycarbonate, polyimide, polyetherether ketone, polyether sulfone, polyphenylene oxide, polyphenylene sulfidro, polyethylene naphthalene, polyvinylidene fluoride, polyethylene oxide, polyacrylonitrile, polyvinylidene fluoride-hexafluoropropylene copolymer, polyethylene, polypropylene, or combinations thereof. However, other polyolefin-based substrates known to one skilled in the art may be used.

The porous substrate used in the separator (a) and the organic/inorganic composite porous film (b) may take the form of a membrane or fiber. When the porous substrate is fibrous, it may be a nonwoven web forming a porous web (preferably, spunbond type web having long fibers or melt blown type web).

Although there is no particular limitation in the thickness of the porous substrate used in the separator (a) and the organic/inorganic composite porous film (b), the porous substrate preferably has a thickness of between 1 μm and 100 μm, more preferably of between 5 μm and 50 μm. Although there is no particular limitation in the pore size and porosity of the porous substrate, the porous substrate preferably has a porosity of between 5% and 99%. The pore size (diameter) preferably ranges from 0.01 μm to 50 μm, more preferably from 0.1 μm to 20 μm.

Among the above-described three types of porous substrates, the organic/inorganic composite porous film (b) includes a porous substrate having pores, coated with a mixture of inorganic particles with a binder polymer, while the organic/inorganic composite porous film (c) is a free standing film including inorganic particles and a binder polymer. These types of porous substrates permit interstitial volumes to be formed among the inorganic particles, thereby serving to form micropores and to maintain the physical shape as a spacer. Herein, the binder polymer serves to fix the inorganic particles and link the inorganic particles among themselves.

There is no particular limitation in selection of the inorganic particles, as long as they are electrochemically stable. In other words, there is no particular limitation in the inorganic particles that may be used in the present invention, as long as they are not subjected to oxidation and/or reduction at the range of drive voltages (for example, 0-5 V based on Li/Li⁺) of a battery, to which they are applied. Particularly, it is preferable to use inorganic particles having ion conductivity as high as possible, because such inorganic particles can improve the quality of an electrochemical device by increasing the ion conductivity in an electrochemical device. Additionally, when inorganic particles having a high density are used, they are not readily dispersed during a coating step and may increase the weight of a battery to be manufactured. Therefore, it is preferable to use inorganic particles having a density as low as possible. Further, when inorganic particles having a high dielectric constant are used, they can contribute to increase the dissociation degree of an electrolyte salt in a liquid electrolyte, such as a lithium salt, thereby improving the ion conductivity of the electrolyte. Further, because the inorganic particles do not change their physical properties even at a high temperature of 200° C. or higher, the organic/inorganic composite porous film using the inorganic particles can have excellent heat resistance.

For these reasons, the inorganic particles that may be used in the organic/inorganic composite porous films (b) and (c) are selected from the inorganic particles having a high dielectric constant of 5 or more, preferably of 10 or more, inorganic particles having lithium conductivity, or mixtures thereof. This is because such inorganic particles can improve the safety of a battery and can prevent degradation in the battery quality due to their heat resistance and conductivity.

Particular non-limiting examples of the inorganic particles having a dielectric constant of 5 or more include BaTiO₃, Pb(Zr,Ti)O₃ (PZT), Pb₁₋ₓLaₓZr_{1-y}Ti_{y}O₃ (PLZT), PB(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃, TiO₂, SiC, or mixtures thereof.

As used herein, “inorganic particles having lithium ion conductivity” refer to inorganic particles containing lithium elements and having a capability of conducting lithium ions without storing lithium. Inorganic particles having lithium ion conductivity can conduct and transfer lithium ions due to defects present in their structure, and thus can improve lithium ion conductivity and contribute to improve the quality of a battery. Non-limiting examples of such inorganic particles having lithium ion conductivity include: lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} type glass (0<x<4, 0<y<13) such as 14Li₂O-9Al₂O₃-38TiO₂-39P₂O₅, lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), such as Li_{3.25}Ge_{0.25}P_{0.75}S₄, lithium nitrides (LiₓN_{y}, 0<x<4, 0<y<2) such as Li₃N, SiS₂ type glass (LiₓSi_{y}S_{z}, 0<x<3, 0<y<2, 0<z<4) such as Li₃PO₄—Li₂S—SiS₂, P₂S₅ type glass (LiₓP_{y}S_{z}, 0<x<3, 0<y<3, 0<z<7) such as Lil-LI₂S—P₂S₅, or mixtures thereof.

The above-described inorganic particles, for example Pb(Zr,Ti)O₃ (PZT), Pb₁₋ₓLaₓZr_{1-y}Ti_{y}O₃(PLZT), Pb(Mg₃Nb_{2/3})O₃—PbTiO₃(PMN-PT), hafnia (HfO₂), etc., have a high dielectric constant of 100 or more. The inorganic particles also have piezoelectricity, so that an electric potential can be generated between both surfaces by the charge formation, when they are drawn or compressed under the application of a certain pressure. Therefore, the inorganic particles can prevent an internal short circuit between both electrodes, thereby contributing to improve the safety of a battery. Additionally, when such inorganic particles having a high dielectric constant are combined with inorganic particles having lithium ion conductivity, synergic effects can be obtained.

The organic/inorganic composite porous film according to the present invention can form pores having a size of several micrometers by controlling the size of inorganic particles, content of inorganic particles and the mixing ratio of inorganic particles and binder polymer. It is also possible to control the pore size and porosity.

Although there is no particular limitation in the size of the inorganic particles, inorganic particles preferably have a size of 0.01-10 μm. Also, there is no particular limitation in the content of the inorganic particles. However, the inorganic particles are present in the mixture of the inorganic particles with binder polymer forming the organic/inorganic composite porous film, preferably in an amount of 50-99 wt %, more particularly in an amount of 60-95 wt % based on 100 wt % of the total weight of the mixture.

The binder polymer that may be used in the organic/inorganic composite porous films (b) and (c) includes a polymer currently used in the art. It is preferable to use a polymer having a solubility parameter of between 15 and 45 MPa^{1/2}, depending on the particular electrolyte to be used in a battery. More preferably, a polymer that is swellable in an electrolyte and having a solubility parameter of between 18.0 and 30 [J^{1/2}/CM^{3/2}] is used. The binder polymer causes the inorganic particles to be linked among them and to be fixed stably. Thus the binder polymer contributes to prevent degradation in the mechanical properties of a final organic/inorganic composite porous film and to increase the infiltration ratio of electrolyte, thereby improving the quality of a battery.

Non-limiting examples of the binder polymer that may be used in the present invention include polyvinylidene fluoride-co-hexafluoropropylene, poly vinylidene fluoride-co-trichloroethylene, polymethyl methacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethyl pullulan, cyanoethyl polyvinylalcohol, cyanoethyl cellulose, cyanoethylsucrose, pullulan, carboxymethyl cellulose, or mixtures thereof.

The organic/inorganic composite porous films (a) and (b) may be manufactured by a conventional process known to one skilled in the art. One embodiment of the method includes the steps of: (a) dissolving a polymer into a solvent to form a polymer solution; (b) adding inorganic particles to the polymer solution obtained from step (a) and mixing them; and (c) coating the mixture of inorganic particles with binder polymer obtained from step (b) on a substrate, followed by drying, and optionally removing the substrate.

The organic/inorganic composite porous film obtained as described above may be provided in the above three types (a)-(c). Among these types, the organic/inorganic composite porous film (c), obtained by using a mixture of inorganic particles with a binder, has a micrometer sized pore structure due to the interstitial volumes present among the inorganic particles that function not only as supports but also as spacers. Additionally, the organic/inorganic composite porous film (b) formed by coating the above mixture on a porous substrate includes pores provided by the porous substrate itself and has pore structures in the substrate as well as in the active layer due to the pores present in the porous substrate itself and the interstitial volumes present among the inorganic particles on the substrate. Although there is no particular limitation in the pore size and porosity of a resulting porous film, formed by coating styrene-butadiene rubber on any one type of substrate selected from types (a)-(c), the porous film preferably has a porosity of 10-99% and a pore size (diameter) of 0.001-10 μm. If the porous film has a pore size of less than 0.001 μm and a porosity of less than 10%, an electrolyte cannot move smoothly through the porous film, resulting in degradation in the quality of a battery. On the other hand, the porous film has a pore size of greater than 10 μm and a porosity of greater than 99%, the porous film cannot maintain physical properties, and thus causes possibility of an internal short circuit between a cathode and anode. Also, there is no particular limitation in the thickness of the porous film. However, the porous film preferably has a thickness of 1-100 μm, more preferably of 5-50 μm. If the porous film has a thickness of less than 1 μm, it cannot maintain physical properties. On the other hand, if the porous film has a thickness of greater than 100 μm, it may function as a resistance layer.

In one embodiment of the method for manufacturing a porous film coated with styrene-butadiene rubber, a porous substrate having pores is coated with styrene-butadiene rubber, and then the coated substrate is dried.

Herein, styrene-butadiene rubber may be used in the form of an emulsion. Also, styrene-butadiene rubber may be dispersed into a solvent having a solubility parameter similar to the solubility parameter of the rubber and a low boiling point, preferably into water, and then used.

In order to coat the above three types of porous films with the emulsion of styrene-butadiene rubber, any methods known to one skilled in the art may be used. It is possible to use various processes including dip coating, die coating, roll coating, comma coating or combinations thereof. Additionally, when the mixture containing inorganic particles and polymer is coated on the porous substrate, either or both surfaces of the porous substrate may be coated. The drying step may be performed in a manner generally known to one skilled in the art.

The porous film according to the embodiment of the present invention, obtained as described above, may be used as a separator in an electrochemical device.

Additionally, the present invention provides an electrochemical device including a cathode; an anode; the porous film coated with styrene-butadiene rubber according to the embodiment of the present invention; and an electrolyte.

Such electrochemical devices include any devices in which electrochemical reactions occur, and particular examples thereof include all kinds of primary batteries, secondary batteries, fuel cells, solar cells or capacitors. Particularly, the electrochemical device is a lithium secondary battery including a secondary lithium metal battery, secondary lithium ion battery, secondary lithium polymer battery, or a secondary lithium ion polymer battery.

The electrochemical device using the porous film according to the embodiment of the present invention may be manufactured by a conventional method known to one skilled in the art. In one embodiment of the method for manufacturing the electrochemical device, the electrochemical device is assembled by interposing the porous film coated with styrene-butadiene rubber between a cathode and anode to form an assembly, and an electrolyte is injected into the assembly.

Meanwhile, adhesion of the porous film according to the embodiment of the present invention to other substrates (preferably, both electrodes) largely depends on the physical properties of styrene-butadiene rubber used for forming a coating layer. In fact, excellent adhesion can be obtained through high polarity or low glass transition temperature of styrene-butadiene rubber. The porous film according to the embodiment of the present invention is useful for various processes requiring adhesion between an electrode and a separator, including a winding process, lamination or stacking process and a folding process. Therefore, electrochemical devices can be manufactured by way of various types of processes.

The electrode used in the electrochemical device according to the present invention may be formed by applying an electrode active material on a current collector according to a method known to one skilled in the art.

Particularly, cathode active materials may include any conventional cathode active materials currently used in a cathode of a conventional electrochemical device. Particular non-limiting examples of the cathode active material include lithium intercalation materials such as lithium manganese oxides, lithium cobalt oxides, lithium nickel oxides, lithium iron oxides or composite oxides thereof. Additionally, anode active materials may include any conventional anode active materials currently used in an anode of a conventional electrochemical device. Particular non-limiting examples of the anode active material include lithium intercalation materials such as lithium metal, lithium alloys, carbon, petroleum coke, activated carbon, graphite or other carbonaceous materials. Non-limiting examples of a cathode current collector include foil formed of aluminum, nickel or a combination thereof. Non-limiting examples of an anode current collector include foil formed of copper, gold, nickel, copper alloys or a combination thereof.

The electrolyte that may be used in the present invention includes a salt represented by the formula of A⁺B⁻ wherein, A⁺ represents an alkali metal cation selected from the group consisting of Li⁺, Na⁺, K⁺ and combinations thereof, and B⁻ represents an anion selected from the group consisting of PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, C(CF₂SO₂)₃⁻ and combinations thereof. The salt may be dissolved or dissociated in an organic solvent selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL) and mixtures thereof. However, the electrolyte that may be used in the present invention is not limited to the above examples.

More particularly, the electrolyte may be injected in a suitable step during the manufacturing process of an electrochemical device, according to the particular manufacturing process to be used and desired properties of a final product. In other words, electrolyte may be injected, before an electrochemical device is assembled or in a final step during the assemblage of an electrochemical device.

There is no particular limitation in the outer shape of the electrochemical device obtained in the above-described manner. The electrochemical device may be a cylindrical, prismatic, pouch-type or coin-type electrochemical device.

### BEST MODE FOR CARRYING OUT THE INVENTION

Reference will now be made in detail to the preferred embodiments of the present invention. It is to be understood that the following examples are illustrative only and the present invention is not limited thereto.

### REFERENCE EXAMPLE

Variations in Ion Conductivity Depending on Content of Inorganic Particles

The organic/inorganic composite system according to the present invention was observed to determine variations in ion conductivity depending on the content of inorganic particles.

The organic/inorganic composite film according an embodiment of to the present invention was dipped into the electrolyte formed of ethylene carbonate/propylene carbonate/diethyl carbonate (EC/PC/DEC=30:20:50 on the basis of wt %) containing 1M lithium hexafluorophosphate (LiPF₆) dissolved therein. The film, into which the electrolyte is impregnated, was measured for ion conductivity by using Metrohm 712 instrument at a temperature of 25° C.

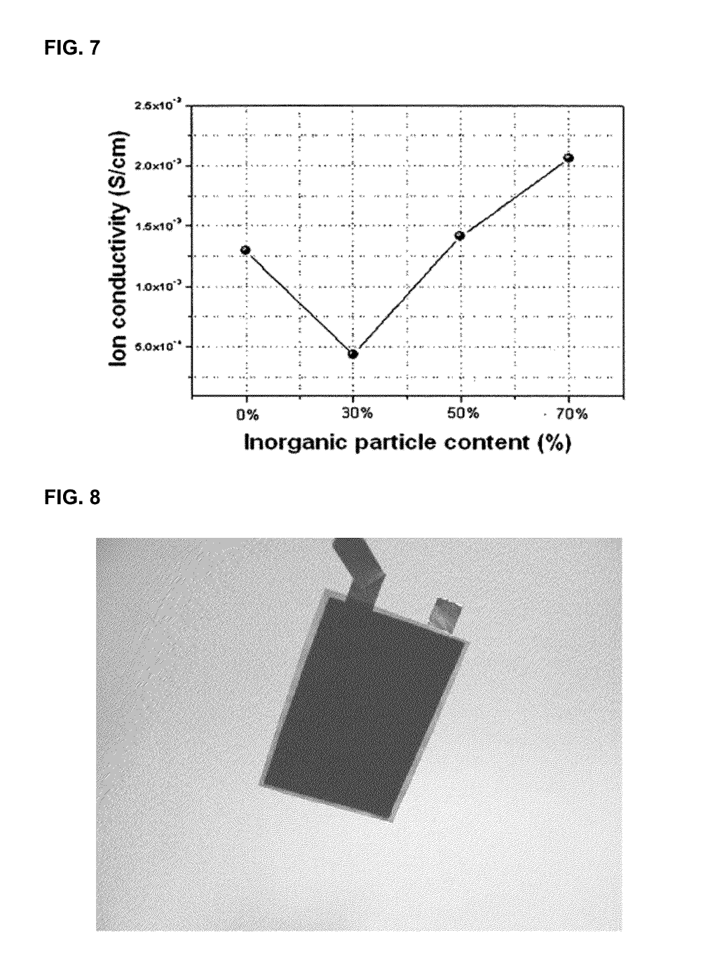

As shown in FIG. 7, as the content of inorganic particles increases, ion conductivity also increases. Particularly, when 50 wt % or more of inorganic particles are used, ion conductivity increases significantly.

### Example 1-9

### Preparation of Organic/Inorganic Composite Porous Film and Manufacture of Lithium Secondary Battery Using the Same

### Example 1

### 1-1. Preparation of Organic/Inorganic Composite Porous Film (PVdF-HFP/BaTiO₃)

PVdF-HFP polymer (polyvinylidene fluoride-hexafluoropropylene copolymer) was added to tetrahydrofuran (THF) in the amount of about 5 wt % and dissolved therein at 50° C. for about 12 hours or more to form a polymer solution. To the polymer solution obtained as described above, BaTiO₃ powder having a particle diameter of about 400 nm was added with the concentration of 20 wt % on the total solid content basis, and then dispersed to form a mixed solution (BaTiO₃/PVDF-HFP=80:20 (weight ratio)). Then, the mixed solution obtained as described above was coated on a Teflon sheet by using a doctor blade coating method. After coating, THF was dried and the Teflon sheet was detached to obtain a final organic/inorganic composite porous film (see, FIG. 1). The final film had a thickness of about 30 μm. After measuring with a porosimeter, the final organic/inorganic composite porous film had a pore size of 0.4 μm and a porosity of 60%.

### 1-2. Manufacture of Lithium Secondary Battery

(Manufacture of Cathode)

To N-methyl-2-pyrrolidone (NMP) as a solvent, 94 wt % of lithium cobalt composite oxide (LiCoO₂) as cathode active material, 3 wt % of carbon black as conductive agent and 3 wt % of PVdF (polyvinylidene fluoride) as binder were added to form slurry for a cathode. The slurry was coated on Al foil having a thickness of 20 μm as cathode collector and dried to form a cathode.

(Manufacture of Anode)

To N-methyl-2-pyrrolidone (NMP) as solvent, 96 wt % of carbon powder as anode active material, 3 wt % of PVdF (polyvinylidene fluoride) as binder and 1 wt % of carbon black as conductive agent were added to form mixed slurry for an anode. The slurry was coated on Cu foil having a thickness of 10 μm as anode collector and dried to form an anode.

(Manufacture of Battery)

The cathode and anode obtained as described above were stacked with the organic/inorganic composite porous film obtained as described in Example 1-1 to form an assembly. Then, an electrolyte (ethylene carbonate (EC)/propylene carbonate (PC)/diethyl carbonate (DEC)=30:20:50 (wt %) containing 1M of lithium hexafluorophosphate (LiPF₆)) was injected thereto to provide a lithium secondary battery.

### Example 2

Example 1 was repeated to provide a lithium secondary battery, except that mixed powder of BaTiO₃ and Al₂O₃ (weight ratio=20:80) was used instead of BaTiO₃ powder to obtain an organic/inorganic composite porous film (PVdF-HFP/BaTiO₃—Al₂O₃). After measuring with a porosimeter, the final organic/inorganic composite porous film had a thickness of 25 μm, pore size of 0.3 μm and a porosity of 57%.

### Example 3

Example 1 was repeated to provide a lithium secondary battery, except that PMNPT (lead magnesium niobate-lead titanate) powder was used instead of BaTiO₃ powder to obtain an organic/inorganic composite porous film (PVdF-HFP/PMNPT). After measuring with a porosimeter, the final organic/inorganic composite porous film had a thickness of 30 μm, pore size of 0.3 μm and a porosity of 60%.

### Example 4

Example 1 was repeated to provide a lithium secondary battery, except that PVdF-HFP was not used but about 2 wt % of carboxymethyl cellulose (CMC) polymer was added to water and dissolved therein at 60° C. for about 12 hours or more to form a polymer solution, and the polymer solution was used to obtain an organic/inorganic composite porous film (CMC/BaTiO₃). After measuring with a porosimeter, the final organic/inorganic composite porous film had a thickness of 25 μm, pore size of 0.4 μm and a porosity of 58%.

### Example 5

Example 1 was repeated to provide a lithium secondary battery, except that PZT powder was used instead of BaTiO₃ powder to obtain an organic/inorganic composite porous film (PVdF-HFP/PZT). After measuring with a porosimeter, the final organic/inorganic composite porous film had a thickness of 25 μm, pore size of 0.4 μm and a porosity of 62%.

### Example 6

Example 1 was repeated to provide a lithium secondary battery, except that PLZT powder was used instead of BaTiO₃ powder to obtain an organic/inorganic composite porous film (PVdF-HFP/PLZT). After measuring with a porosimeter, the final organic/inorganic composite porous film had a thickness of 25 μm, pore size of 0.3 μm and a porosity of 58%.

### Example 7

Example 1 was repeated to provide a lithium secondary battery, except that HfO₂ powder was used instead of BaTiO₃ powder to obtain an organic/inorganic composite porous film (PVdF-HFP/HfO₂). After measuring with a porosimeter, the final organic/inorganic composite porous film had a thickness of 28 μm, pore size of 0.4 μm and a porosity of 60%.

### Example 8

Example 1 was repeated to provide a lithium secondary battery, except that lithium titanium phosphate (LiTi₂(PO₄)₃) powder having a particle diameter of about 400 nm was used in an amount of the total solid content of 20 wt %, instead of BaTiO₃ powder, to obtain an organic/inorganic composite porous film (PVdF-HFP/LiTi₂(PO₄)₃) having a thickness of about 20 μm. After measuring with a porosimeter, the final organic/inorganic composite porous film had a pore size of 0.5 μm and porosity of 62%.

### Example 9

Example 1 was repeated to provide a lithium secondary battery, except that mixed powder of BaTiO₃ and LiTi₂(PO₄)₃ (weight ratio=50:50) was used instead of BaTiO₃ powder to obtain an organic/inorganic composite porous film (PVdF-HFP/LiTi₂(PO₄)₃—BaTiO₃). After measuring with a porosimeter, the final organic/inorganic composite porous film had a thickness of 25 μm, pore size of 0.3 μm and a porosity of 60%.

### Comparative Examples 1-4

### Comparative Example 1

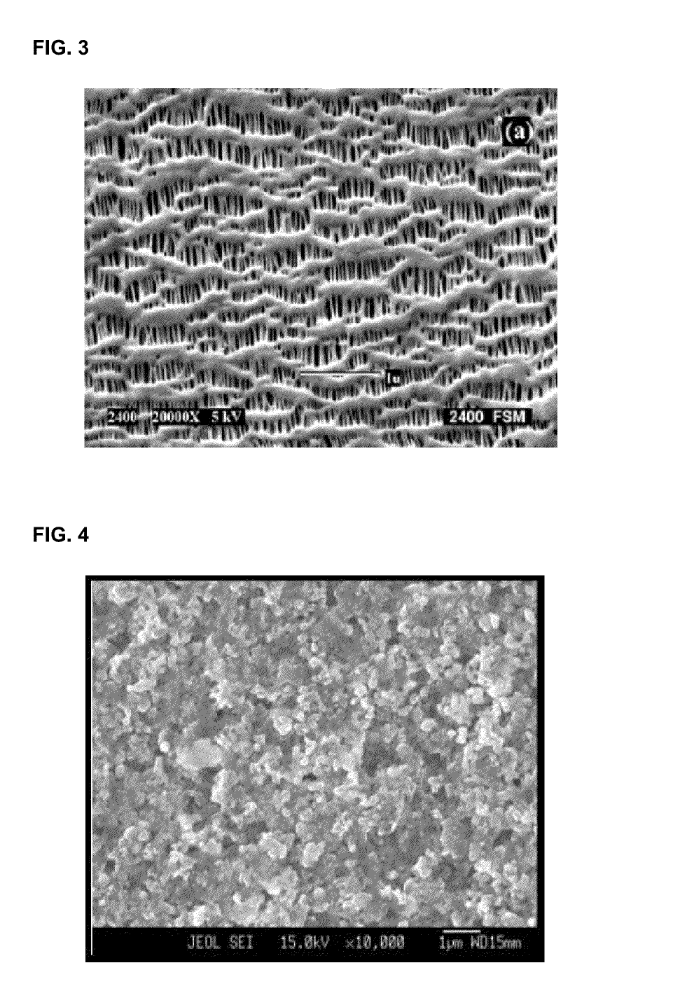

Example 1 was repeated to provide a lithium secondary battery, except that a conventional poly propylene/polyethylene/polypropylene (PP/PE/PP) separator (see, FIG. 3) was used.

### Comparative Example 2

Example 1 was repeated to provide an organic/inorganic composite porous film and lithium secondary battery having the same, except that BaTiO₃ and PVDF-HFP were used in a weight ratio of 20:80. After measuring the BaTiO₃/PVdF-HFP with a porosimeter, the final organic/inorganic composite porous film had a pore size of 0.01 μm or less and a porosity of about 10%.

### Comparative Example 3

Example 1 was repeated to provide an organic/inorganic composite porous film and lithium secondary battery having the same, except that LiTi₂(PO₄)₃ and PVDF-HFP were used in a weight ratio of 10:90. After measuring the LiTi₂(PO₄)₃/PVdF-HFP with a porosimeter, the final organic/inorganic composite porous film had a pore size of 0.01 μm or less and a porosity of about 5%.

### Comparative Example 4

### Manufacture of Porous Film Using Plasticizer

Dimethyl carbonate (DMC) was selected as plasticizer and used along with PVdF-HFP in a ratio of 30:70 (on the wt % basis) and THF as solvent to form a porous film. Dimethyl carbonate used in the film as plasticizer was extracted from the film by using methanol to provide a final porous film and a lithium secondary battery having the same. After measuring the porous PVdF-HFP film with a porosimeter, the porous film had a pore size of 0.01 μm or less and a porosity of about 30% (see, FIG. 4).

### Experimental Example 1

### Surface Analysis of Organic/Inorganic Composite Porous Film

The following test was performed to analyze the surface of an organic/inorganic composite porous film according to the present invention.

The sample used in this test was PVdF-HFP/BaTiO₃ obtained according to Example 1. As controls, a PP/PE/PP separator according to Comparative Example 1 and the porous film using a plasticizer according to Comparative Example 4 were used.

When analyzed by using Scanning Electron Microscope (SEM), the PP/PE/PP separator according to Comparative Example 1 and the porous film according to Comparative Example 4 showed a conventional microporous structure (see, FIGS. 3 and 4). More particularly, the porous film according to Comparative Example 4 had a dense pore structure formed independently from the inorganic particles present on the surface of the film. It is thought that the dense pore structure is formed by artificial extraction of the plasticizer.

On the contrary, the organic/inorganic composite porous film according to the present invention showed a micropore structure formed by the inorganic particles as main component of the film (for example, inorganic particles with a high dielectric constant and/or lithium ion conductivity). Additionally, it could be seen that the polymer was coated on the surface of the inorganic particles (see, FIG. 2).

### Experimental Example 2

### Evaluation of Heat Shrinkage of Organic/Inorganic Composite Porous Film

The following experiment was performed to compare the organic/inorganic composite porous film with a conventional separator.

The organic/inorganic composite porous film (PVdF-CTFE/BaTiO₃) according to Example 1 was used as sample. A conventional PP/PE/PP separator and PE separator were used as controls.

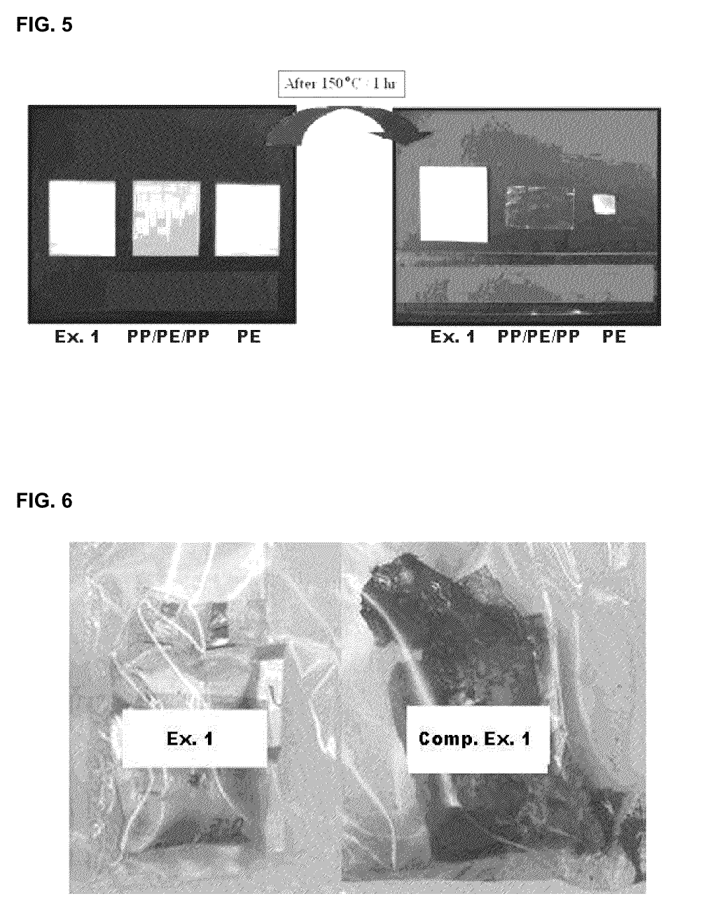

Each of the test samples was checked for its heat shrinkage after stored at a high temperature of 150° C. for 1 hour. The test samples provided different results after the lapse of 1 hour at 150° C. The PP/PE/PP separator as control was shrunk due to high temperature to leave only the outer shape thereof. Similarly, the PE separator was shrunk to about 1/10 of its original size. On the contrary, the organic/inorganic composite porous film according to the present invention showed good results with no heat shrinkage (see, FIG. 5).

As can be seen from the foregoing, the organic/inorganic composite porous film according to the present invention has excellent thermal safety.

### Experimental Example 3

### Evaluation for Safety of Lithium Secondary Battery

The following test was performed to evaluate the safety of each lithium secondary battery having the organic/inorganic composite porous film according to the present invention.

Lithium secondary batteries according to Examples 1-9 were used as samples. As controls, used were the battery using a currently used PP/PE/PP separator according to Comparative Example 1, the battery using the BaTiO₃/PVdF-HFP film (weight ratio=20:80 on the wt % basis) as separator according to Comparative Example 2, and the battery using the LiTi₂(PO₄)₃/PVdF-HFP film (weight ratio=10:90 on the wt ° A) basis) as separator according to Comparative Example 3.

### 3-1. Hot Box Test

Each battery was stored at high temperatures of 150° C. and 160° C. for 1 hour and then checked. The results are shown in the following Table 1.

After storing at high temperatures, the battery using a currently used PP/PE/PP separator according to Comparative Example 1 caused explosion when stored at 160° C. for 1 hour. This indicates that polyolefin-based separators cause extreme heat shrinking, melting and breakage when stored at high temperature, resulting in internal short circuit between both electrodes (i.e., a cathode and an anode) of a battery. On the contrary, lithium secondary batteries having an organic/inorganic composite porous film according to the present invention showed such a safe state as to prevent firing and burning even at a high temperature of 160° C. (see, Table 1).

Therefore, it can be seen that the lithium secondary battery having an organic/inorganic composite porous film according to the present invention has excellent thermal safety.

TABLE 1

Hot Box Test Conditions

| | 150° C./1 hr | 160° C./1 hr |
|---|---|---|
| Ex. 1 | ◯ | ◯ |
| Ex. 2 | ◯ | ◯ |
| Ex. 3 | ◯ | ◯ |
| Ex. 4 | ◯ | ◯ |
| Ex. 5 | ◯ | ◯ |
| Ex. 6 | ◯ | ◯ |
| Ex. 7 | ◯ | ◯ |
| Ex. 8 | ◯ | ◯ |
| Ex. 9 | ◯ | ◯ |
| Comp. Ex. 1 | ◯ | X |
| Comp. Ex. 2 | ◯ | ◯ |
| Comp. Ex. 3 | ◯ | ◯ |

### 3-2. Overcharge Test

Each battery was charged under the conditions of 6V/1 A and 10V/1 A and then checked. The results are shown in the following Table 2.

After checking, the battery using a currently used PP/PE/PP separator according to Comparative Example 1 exploded (see, FIG. 6). This indicates that the polyolefin-based separator is shrunk by overcharge of the battery to cause short circuit between electrodes, resulting in degradation in safety of the battery. On the contrary, each lithium secondary battery having an organic/inorganic composite porous film according to the present invention showed excellent safety under overcharge conditions (see, Table 2 and FIG. 6).

TABLE 2

Overcharge Test Conditions

| | 6 V/1 A | 10 V/1 A |
|---|---|---|
| Ex. 1 | ◯ | ◯ |
| Ex. 2 | ◯ | ◯ |
| Ex. 3 | ◯ | ◯ |
| Ex. 4 | ◯ | ◯ |
| Ex. 5 | ◯ | ◯ |
| Ex. 6 | ◯ | ◯ |
| Ex. 7 | ◯ | ◯ |
| Ex. 8 | ◯ | ◯ |
| Ex. 9 | ◯ | ◯ |
| Comp. Ex. 1 | ◯ | X |
| Comp. Ex. 2 | ◯ | ◯ |
| Comp. Ex. 3 | ◯ | ◯ |

### Experimental Example 4

### Evaluation for Quality of Lithium Secondary Battery

The following tests were performed in order to determine the charge/discharge capacity of each lithium secondary battery having an organic/inorganic composite porous film according to the present invention.

Lithium secondary batteries according to Examples 1-9 were used as samples. As controls, used were the battery using a currently used PP/PE/PP separator according to Comparative Example 1, the battery using the BaTiO₃/PVdF-HFP film (weight ratio=20:80 on the wt % basis) as separator according to Comparative Example 2, the battery using the LiTi₂(PO₄)₃/PVdF-HFP film (weight ratio=10:90 on the wt basis) as separator according to Comparative Example 3, and the battery using the porous PVdF-HFP film obtained by using a plasticizer as separator according to Comparative Example 4.

Each battery having a capacity of 760 mAh was subjected to cycling at a discharge rate of 0.5 C, 1 C and 2 C. The following Table 3 shows the discharge capacity of each battery, the capacity being expressed on the basis of C-rate characteristics.

After performing the test, the battery according to Comparative Examples 2 using, as separator, an organic/inorganic composite porous film that includes a mixture containing inorganic particles with a high dielectric constant and a binder polymer in a ratio of 20:80 (on the wt % basis) and the battery according to Comparative Examples 3 using, as separator, an organic/inorganic composite porous film that includes a mixture containing inorganic particles with lithium ion conductivity and a binder polymer in a ratio of 10:90 (on the wt % basis), showed a significant drop in capacity depending on discharge rates, as compared to the batteries using, as separators, the organic/inorganic composite porous film obtained from the above Examples according to the present invention and a conventional polyolefin-based separator (see, Table 3). This indicates that such relatively low amount of inorganic particles compared to the polymer may decrease the pore size and porosity in the pore structure formed by interstitial volume among the inorganic particles, resulting in degradation in the quality of a battery. Additionally, the battery using the porous film having a pore structure artificially formed by using a plasticizer as separator according to Comparative Example 4 also showed a significant drop in capacity depending on discharge rates in the same manner as the batteries according to Comparative Examples 2 and 3.

On the contrary, lithium secondary batteries having the organic/inorganic composite porous film according to the present invention showed C-rate characteristics comparable to those of the battery using a conventional polyolefin-based separator under a discharge rate of up to 2 C (see, Table 3).

TABLE 3

| | Discharge Rate (mAh) | | |
|---|---|---|---|
| | 0.5 C | 1 C | 2 C |
| Ex. 1 | 757 | 746 | 694 |
| Ex. 2 | 756 | 748 | 693 |
| Ex. 3 | 756 | 744 | 691 |
| Ex. 4 | 758 | 747 | 694 |
| Ex. 5 | 759 | 750 | 698 |
| Ex. 6 | 755 | 742 | 690 |
| Ex. 7 | 758 | 747 | 694 |
| Ex. 8 | 756 | 745 | 793 |
| Ex. 9 | 757 | 746 | 792 |
| Comp. Ex. 1 | 758 | 746 | 693 |
| Comp. Ex. 2 | 695 | 562 | 397 |
| Comp. Ex. 3 | 642 | 555 | 385 |
| Comp. Ex. 4 | 698 | 585 | 426 |

As can be seen from the foregoing, the organic/inorganic composite porous film according to the present invention includes inorganic particles and a binder polymer. The inorganic particles are interconnected among themselves and fixed by the binder polymer and interstitial volumes among the inorganic particles form a heat resistant micropore structure. Therefore, it is possible to increase the space to be filled with an electrolyte, and thus to improve a degree of swelling with electrolyte and lithium ion conductivity. As a result, the organic/inorganic composite porous film according to the present invention improves the thermal safety and quality of a lithium secondary battery using the same as separator.

### Example 10

### 10-1. Manufacture of Organic/Inorganic Composite Porous Film Coated with SBR

PVdF-HFP copolymer (polyvinylidene fluoride-hexafluoropropylene copolymer) was added to tetrahydrofuran (THF) in the amount of about 5 wt % and dissolved therein at 50° C. for about 12 hours or more to form a polymer solution. To the polymer solution obtained as described above, barium titanate (BaTiO₃) powder was added to the concentration of 20 wt % on the solid content basis, so as to be dispersed in the polymer solution. By doing so, a mixed solution (BaTiO₃/PVdF-HFP=70/30 (weight percent ratio)) was obtained. Then, the mixed solution obtained as described above was coated on a porous polyethylene terephthalate substrate (porosity: 80%) having a thickness of about 20 μm by using a dip coating process to a coating layer thickness of about 2 μm. After measuring with a porosimeter, the active layer infiltrated into and coated on the porous polyethylene terephthalate substrate had a pore size of 0.4 μm and a porosity of 58%.

The organic/inorganic composite porous film obtained as described above was coated with a solution containing 5 wt % of styrene-butadiene rubber (LG Chem., Ltd.) dispersed therein, by way of dip coating, and then dried. The styrene-butadiene rubber was comprised of styrene (23%), butadiene (67%), nitrile groups (5%) and carboxyl groups (5%).

### 10-2. Manufacture of Lithium Secondary Battery

(Manufacture of Cathode)

To N-methyl-2-pyrrolidone (NMP) as a solvent, 94 wt % of lithium cobalt composite oxide (LiCoO₂) as a cathode active material, 43 wt % of carbon black as a conductive agent and 3 wt % of PVDF (polyvinylidene fluoride) as a binder were added to form slurry for a cathode. The slurry was coated on Al foil having a thickness of 20 μm as a cathode collector and dried to form a cathode.

(Manufacture of Anode)

To N-methyl-2-pyrrolidone (NMP) as a solvent, 96 wt % of carbon powder as an anode active material, 3 wt % of PVDF (polyvinylidene fluoride) as a binder and 1 wt ° A) of carbon black as a conductive agent were added to form mixed slurry for an anode. The slurry was coated on Cu foil having a thickness of 10 μm as an anode collector and dried to form an anode.

(Manufacture of Battery)

The cathode and anode obtained as described above were laminated with the organic/inorganic composite porous film obtained as described in Example 10 to form an assembly. Then, an electrolyte (ethylene carbonate (EC)/propylene carbonate (PC)/diethyl carbonate (DMC)=30:20:50 (weight percent ratio) containing 1M of lithium hexafluorophosphate (LiPF₆)) was injected thereto to provide a lithium secondary battery.

### Comparative Example 5

Example 10 was repeated to provide an organic/inorganic composite porous film and a lithium secondary battery, except that the organic/inorganic composite porous film (BaTiO₃/PVdF-HFP) was not coated with a solution containing styrene-butadiene rubber dispersed therein.

### Experimental Example 5

### Evaluation for Binding Capability and Adhesion

The following test was performed to evaluate the binding capability and adhesion of the organic/inorganic composite porous film coated with SBR according to the present invention.

1. Evaluation for Adhesion to Other Substrates

Each of the organic/inorganic composite porous films according to Example 10 and Comparative Example 5 was laminated with an electrode, and adhesion between the film and the electrode was evaluated.

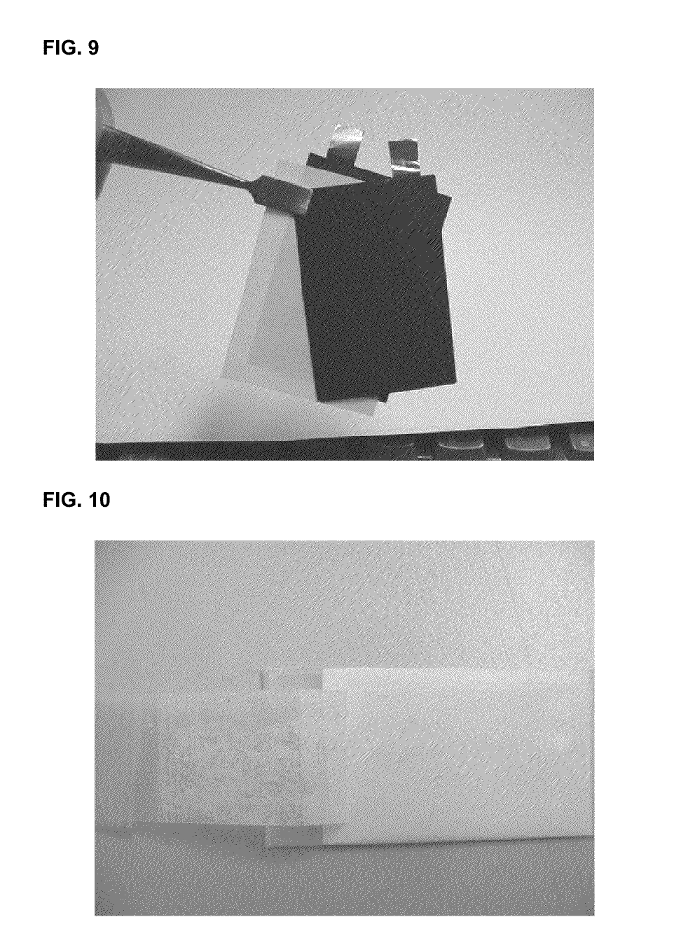

After the evaluation, the organic/inorganic composite porous film coated with styrene-butadiene rubber according to the present invention (BaTiO₃/PVdF-HFP) showed excellent adhesion to an electrode (see FIG. 8), while the organic/inorganic composite porous film according to Comparative Example 5 showed poor adhesion (see FIG. 9).

2. Evaluation for Binding Capability

Each of the organic/inorganic composite porous films according to Example 10 and Comparative Example 5 was used as a sample. To perform a peeling test, a tape available from 3M Company was attached to each film sample, and then detached therefrom.

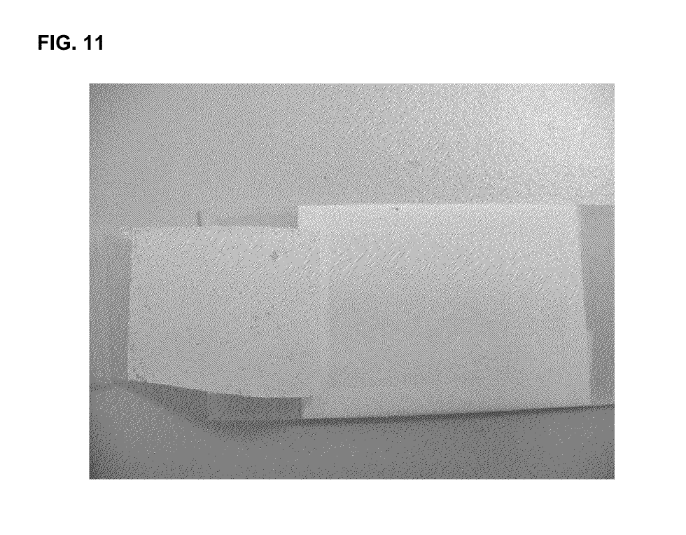

After the test, the porous film coated with styrene-butadiene rubber according to the present invention showed significantly improved binding capability among inorganic particles as well as between the polyester substrate and the film (see FIG. 10). On the contrary, the non-coated organic/inorganic composite porous film according to Comparative Example 5 showed poor binding capability (see FIG. 11).

It can be seen from the above results that the organic/inorganic composite porous film coated with styrene-butadiene rubber according to the present invention can provide significantly improved binding capability and adhesion.

As can be seen from the foregoing, the organic/inorganic composite porous film coated with styrene-butadiene rubber, which imparts excellent adhesion and mechanical strength, according to the present invention can provide improved scratch resistance and adhesion to other substrates. Therefore, when the porous film is used in an electrochemical device as a separator, it is possible to improve the safety of the electrochemical device and to prevent degradation in the quality of the electrochemical device.

### INDUSTRIAL APPLICABILITY

While this invention has been described in connection with what is presently considered to be the most practical and preferred embodiment, it is to be understood that the invention is not limited to the disclosed embodiment and the drawings. On the contrary, it is intended to cover various modifications and variations within the spirit and scope of the appended claims.

What is claimed is:

1. An organic/inorganic composite porous film, which comprises:
(a) inorganic particles; and
(b) a binder polymer coating layer formed partially or totally on surfaces of the inorganic particles, wherein the inorganic particles are interconnected among themselves and are fixed by the binder polymer, and interstitial volumes among the inorganic particles form a micropore structure.

2. The film according to claim 1, wherein the inorganic particles are at least one selected from the group consisting of: (a) inorganic particles having a dielectric constant of 5 or more; and (b) inorganic particles having lithium ion conductivity.

3. The film according to claim 2, wherein the inorganic particles having a dielectric constant of 5 or more are BaTiO₃, Pb(Zr,Ti)O₃ (PZT), Pb₁₋ₓLaₓZr_{1-y}Ti_{y}O₃ (PLZT), Pb(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃, TiO₂ or SiC.

4. The film according to claim 2, wherein the inorganic particles having lithium ion conductivity are at least one selected from the group consisting of: lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} type glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitrides (LiₓN_{y}, 0<x<4, 0<y<2), SiS₂ type glass (LiₓSi_{y}S_{z}, 0<x<3, 0<y<2, 0<z<4) and P₂S₅ type glass (LiₓP_{y}S_{z}, 0<x<3, 0<y<3, 0<z<7).

5. The film according to claim 1, wherein the inorganic particles have a size of between 0.001 μm and 10 μm.

6. The film according to claim 1, wherein the inorganic particles are present in the mixture of inorganic particles with the binder polymer in an amount of 50-99 wt % based on 100 wt % of the mixture.

7. The film according to claim 1, wherein the binder polymer has a glass transition temperature (T_{g}) of between −200° C. and 200° C.

8. The film according to claim 1, wherein the binder polymer has a solubility parameter of between 15 and 45 MPa^{1/2}.

9. The film according to claim 1, wherein the binder polymer is at least one selected from the group consisting of polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, carboxymethyl cellulose, acrylonitrile-styrene-butadiene copolymer and polyimide.

10. The film according to claim 1, which has a pore size of between 0.001 and 10 μm.

11. The film according to claim 1, which has a porosity of between 5% and 95%.

12. The film according to claim 1, which has a thickness of between 1 and 100 μm.

13. An electrochemical device comprising:
(a) a cathode;
(b) an anode;
(c) an organic/inorganic composite porous film, which comprises: (i) inorganic particles; and (ii) a binder polymer coating layer formed partially or totally on surfaces of the inorganic particles, wherein the inorganic particles are interconnected among themselves and are fixed by the binder polymer, and interstitial volumes among the inorganic particles form a micropore structure; and
(d) an electrolyte.

14. The electrochemical device according to claim 13, which is a lithium secondary battery.

15. The electrochemical device according to claim 13, which further comprises a microporous separator.

16. The electrochemical device according to claim 15, wherein the microporous separator is a polyolefin-based separator, or at least one porous substrate having a melting point of 200° C. or higher, selected from the group consisting of polyethylene terephthalate, polybutylene terephthalate, polyester, polyacetal, polyamide, polycarbonate, polyimide, polyetherether ketone, polyether sulfone, polyphenylene oxide, polyphenylene sulfidro and polyethylene naphthalene.

17. A method for manufacturing an organic/inorganic composite porous film according to claim 1, which comprises the steps of:
(a) dissolving a binder polymer into a solvent to form a polymer solution;
(b) adding inorganic particles to the polymer solution obtained from step (a) and mixing them; and
(c) coating the mixture of inorganic particles with binder polymer obtained from step (b) on a substrate, followed by drying the coated substrate.

18. A separator for batteries, which comprises at least one inorganic particle selected from the group consisting of Pb(Zr,Ti)O₃ (PZT), Pb₁,LaₓZr_{1-y}Ti_{y}O₃(PLZT), Pb(Mg₃Nb_{2/3})O₃—PbTiO₃(PMN-PT) and hafnia (HfO₂).

19. A porous film comprising:
(a) a porous substrate having pores; and
(b) a coating layer formed on at least one region selected from the group consisting of a surface of the substrate and a part of the pores present in the substrate,
wherein the coating layer comprises styrene-butadiene rubber.

20. The film according to claim 19, wherein the styrene-butadiene rubber has a glass transition temperature (T_{g}) of 25° C. or less.

21. The film according to claim 19, wherein the styrene-butadiene rubber contains a hydrophilic functional group.

22. The film according to claim 21, wherein the hydrophilic functional group forms a hydrogen bond with other substrates.

23. The film according to claim 19, wherein the styrene-butadiene rubber is obtained by polymerization of: (a) a butadiene group-containing monomer and a styrene group-containing monomer; or (b) a butadiene group-containing monomer, a styrene group-containing monomer and a hydrophilic group-containing monomer having at least one hydrophilic functional group selected from the group consisting of maleic acid, acrylic acid, acrylate, carboxylic acid, nitrile, hydroxyl, acetate, mercapto, ether, ester, amide, amine groups, and halogen atoms.

24. The film according to claim 23, wherein the styrene group-containing monomer and the butadiene group-containing monomer are used in a weight percent ratio of 1:99-99:1.

25. The film according to claim 19, wherein the styrene-butadiene rubber has an average molecular weight of 10,000-1,000,000.

26. The film according to claim 19, wherein the coating layer has a thickness of 0.001-10 μm.

27. The film according to claim 19, wherein the porous substrate having pores is selected from the group consisting of:
(a) a separator;
(b) an organic/inorganic composite porous film, which comprises a porous film having pores, coated with a coating layer comprising a mixture of inorganic particles with a binder polymer, on a surface of the porous substrate and/or on a part of the pores present in the porous substrate; and
(c) an organic/inorganic composite porous film comprising inorganic particles and a binder polymer coating layer partially or totally formed on the surface of the inorganic particles.

28. The film according to claim 27, wherein the organic/inorganic composite porous film (b) and (c) comprise the inorganic particles interconnected and fixed among themselves by the binder polymer, and have a pore structure formed by interstitial volumes of the inorganic particles.

29. The film according to claim 27, wherein the separator and the porous substrate comprise at least one material selected from the group consisting of polyethylene terephthalate, polybutylene terephthalate, polyester, polyacetal, polyamide, polycarbonate, polyimide, polyetherether ketone, polyether sulfone, polyphenylene oxide, polyphenylene sulfidro, polyethylene naphthalene, polyethylene, polypropylene, and polyolefin.

30. The film according to claim 27, wherein the separator and the porous substrate are fibrous substrates including porous web, or membranes.

31. The film according to claim 27, the inorganic particles are at least one selected from the group consisting of: (a) inorganic particles having a dielectric constant of 5 or more; and (b) inorganic particles having lithium ion conductivity.

32. The film according to claim 31, wherein the inorganic particles having a dielectric constant of 5 or more are BaTiO₃, Pb(Zr,Ti)O₃ (PZT), Pb₁₋ₓLaₓZr_{1-y}Ti_{y}O₃ (PLZT), Pb(Mg₃Nb_{2/3})O₃—PbTiO₃ (PMN-PT), hafnia (HfO₂), SrTiO₃, SnO₂, CeO₂, MgO, NiO, CaO, ZnO, ZrO₂, Y₂O₃, Al₂O₃ or TiO₂; and
the inorganic particles having lithium ion conductivity are at least one selected from the group consisting of: lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), (LiAlTiP)ₓO_{y} type glass (0<x<4, 0<y<13), lithium lanthanum titanate (LiₓLa_{y}TiO₃, 0<x<2, 0<y<3), lithium germanium thiophosphate (LiₓGe_{y}P_{z}S_{w}, 0<x<4, 0<y<1, 0<z<1, 0<w<5), lithium nitrides (LiₓN_{y}, 0<x<4, 0<y<2), SiS₂ type glass (LiₓSi_{y}S_{z}, 0<x<3, 0<y<2, 0<z<4) and P₂S₅ type glass (LiₓP_{y}S_{z}, 0<x<3, 0<y<3, 0<z<7).

33. The film according to claim 27, wherein the binder polymer has a solubility parameter of between 15 and 45 MPa^{1/2}.

34. The film according to claim 27, wherein the binder polymer is at least one selected from the group consisting of polyvinylidene fluoride-co-hexafluoropropylene, polyvinylidene fluoride-co-trichloroethylene, polymethylmethacrylate, polyacrylonitrile, polyvinylpyrrolidone, polyvinyl acetate, polyethylene-co-vinyl acetate, polyethylene oxide, cellulose acetate, cellulose acetate butyrate, cellulose acetate propionate, cyanoethylpullulan, cyanoethyl polyvinylalcohol, cyanoethylcellulose, cyanoethylsucrose, pullulan, and carboxymethyl cellulose.

35. The film according to claim 27, wherein the inorganic particles are present in an amount of 50-99 wt % based on 100 wt % of the mixture of the inorganic particles and the binder polymer.

36. The film according to claim 19, which has a pore size of between 0.001 and 10 μm and a porosity of 10-99%.

37. An electrochemical device comprising a cathode, an anode, a separator and an electrolyte, wherein the separator comprises a porous film as claimed in claim 19.

38. The electrochemical device according to claim 37, which is a lithium secondary battery.
